(19) United States
(12) Patent Application Publication
(10) Pub. No.: US 2014/0004411 A1
(43) Pub. Date: Jan. 2, 2014

(54) SEALED BATTERY

(71) Applicants: Tomohiro YOKOYAMA, Toyota-shi (JP); Masaki KOIKE, Nagoya-shi (JP); Akira TSUKUI, Toyota-shi (JP)

(72) Inventors: Tomohiro YOKOYAMA, Toyota-shi (JP); Masaki KOIKE, Nagoya-shi (JP); Akira TSUKUI, Toyota-shi (JP)

(73) Assignee: TOYOTA JIDOSHA KABUSHIKI KAISHA, Toyota-shi (JP)

(21) Appl. No.: 13/921,497

(22) Filed: Jun. 19, 2013

(30) Foreign Application Priority Data
Jun. 29, 2012 (JP) 2012-147898

(51) Int. Cl. H01M 2/36

(52) U.S. Cl. CPC H01M 2/365
USPC 429/185

(57) ABSTRACT

A sealed battery that includes a battery case and a seal member is provided. The battery case includes a pour hole member provided with a pour hole and houses a charge-discharge element. The seal member seals the pour hole, the seal member is butt-welded with the pour hole member, at least a portion at which a reverse surface of the seal member faces the pour hole member each other having a flow channel, and the flow channel extends from a welded site to an opening portion of the pour hole.

### INCORPORATION BY REFERENCE

The disclosure of Japanese Patent Application No. 2012-147898 filed on Jun. 29, 2012 including the specification, drawings and abstract is incorporated herein by reference in its entirety.

### BACKGROUND OF THE INVENTION

1. Field of the Invention

The invention relates to a sealed battery and, more particularly, to a technology of sealing a pour hole with a seal member by welding.

2. Description of Related Art

In conjunction with sealed batteries, such as lithium-ion secondary batteries, nickel-hydrogen secondary batteries, etc., there has been a known structure in which a charge-discharge element (that includes a positive electrode, a negative electrode, a separator, etc.) is housed within a battery case, and in which a pour hole of the battery case is sealed after an electrolytic solution is poured into the battery case. In manufacture of such a sealed battery, after the electrolytic solution is poured into the battery case through the pour hole, the pour hole of the battery case is sealed with a seal member by welding in order to tightly seal the battery so that the electrolytic solution therein does not leak out. The technology of sealing the pour hole of a battery case with a seal member by welding in this manner is known to public (see, e.g., Japanese Patent Application Publication No. 2009-199819 (JP 2009-199819 A)).

JP 2009-199819 A discloses a technology in which a side wall of a seal plug is provided with a groove that extends throughout in the direction of the thickness of the seal plug (i.e., extends throughout the thickness), and in which in order to seal the pour hole with the seal plug, portions of the seal plug other than the groove are welded by laser and then the groove portion is laser-welded, so that the welding failure due to gas that is produced by heat at the time of welding is prevented.

However, in the technology described in JP 2009-199819 A, because it is necessary not only to provide the seal plug with a groove but also to perform welding a plurality of times in order to let out the gas generated at the time of welding, the welding site (portions to be welded) cannot be continuously welded, and therefore the welding process is complicated.

On the other hand, in a butt welding process as shown in FIGS. 7A and 7B in which a lid body (pour hole) of a battery case and a seal lid (seal member) are welded together by laser, welding failure sometimes occurs when the welding is continuously performed from a welding start point to a welding end point via the perimeter of the seal lid so as to form a continuous weld without a break. For example, in the case as shown in FIG. 8 where, during the welding along the perimeter of the seal lid, an extraneous substance, such as an electrolytic solution residue remaining in the pour hole, or the like, vaporizes by the effect of heat at the time of welding, or in the case where, in an end portion of the perimeter weld, the air or gas confined in a space (see FIG. 9) between the lid body (pour hole) and the seal lid expands by the effect of heat at the time of welding, there is a risk that bubbles of the gas or air pass through the weld portion (molten pool), reach the outer side of the weld portion and then rupture at the outer side, resulting in welding failure in the weld portion.

### SUMMARY OF THE INVENTION

Accordingly, the invention has been accomplished in view of the foregoing problem, and provides a sealed battery that prevents welding failure in the butt welding in which a pour hole and a seal member that seals the pour hole are placed butting with each other, and are welded together.

The problem or task to be solved by the invention is as indicated above, and measures for solving this problem or task will be described below.

That is, there is provided a sealed battery that includes: a battery case including a pour hole member provided with a pour hole and housing a charge-discharge element; and a seal member sealing the pour hole, the seal member being butt-welded with the pour hole member. In this sealed battery, at least a portion at which a reverse surface of the seal member faces the pour hole member provided with the pour hole has a flow channel that extends from a welded site to an opening portion of the pour hole.

In the foregoing sealed battery, the seal member may include a groove or a protrusion on the reverse surface of the seal member, and the flow channel includes the groove or is provided using the protrusion. The reverse surface of the seal member may include a plurality of grooves and the plurality of grooves may extend radially. Furthermore, a peripheral end portion of the reverse surface of the seal member may have a tapered portion.

Furthermore, the pour hole member may include a groove or a protrusion on the pour hole member, and the flow channel may include the groove or the flow channel may be provided using the protrusion. The pour hole member may include a plurality of the grooves, and the plurality of the grooves may extend radially.

According to the above-described sealed battery of the invention, there is provided a construction such that it is not necessary to perform welding a plurality of times, and such that gas produced at the time of welding escapes through the flow channel to the large space side within the battery case. Therefore, welding failure can be prevented.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing an overall construction of a sealed battery in accordance with an embodiment of the invention;

FIG. 2 is an elevation sectional view showing an interior of the sealed battery in accordance with the embodiment of the invention;

FIG. 3A is a bottom view showing the configuration of a seal lid of a first example of the embodiment of the invention;

FIG. 3B is a side view of the seal lid of the first example;

FIG. 3C is a side sectional view showing the seal lid and a lid body in the first example when the seal lid is to be welded to the lid body;

FIG. 3D is a side sectional view showing a vicinity of the pour hole of the lid body (without the seal lid) of the first example;

FIG. 3E is a top view showing a vicinity of the pour hole of the lid body of the first example;

FIG. 4A is a bottom view showing the configuration of a seal lid of a second example of the foregoing embodiment of the invention;

FIG. 4B is a side view of the seal lid of the second example;

FIG. 4C is a side sectional view showing the seal lid and a lid body in the second example when the seal lid is to be welded to the lid body;

FIG. 4D is a side sectional view showing a vicinity of the pour hole of the lid body (without the seal lid) of the second example;

FIG. 4E is a top view showing a vicinity of the pour hole of the lid body of the second example;

FIG. 5A is a bottom view showing the configuration of a seal lid of a third example of the foregoing embodiment of the invention;

FIG. 5B is a side view of the seal lid of the third example;

FIG. 5C is a side sectional view showing the seal lid and a lid body in the third example when the seal lid is to be welded to the lid body;

FIG. 5D is a side sectional view showing a vicinity of the pour hole of the lid body (without a seal lid) of the third example;

FIG. 5E is a top view showing a vicinity of the pour hole of the lid body of the third example;

FIG. 6A is a bottom view showing the configuration of a seal lid of a fourth example of the foregoing embodiment of the invention;

FIG. 6B is a side view of the seal lid of the fourth example;

FIG. 6C is a side sectional view showing the seal lid and a lid body in the fourth example when the seal lid is to be welded to the lid body;

FIG. 6D is a side sectional view showing a vicinity of the pour hole of the lid body (without the seal lid) of the fourth example;

FIG. 6E is a top view showing a vicinity of the pour hole of the lid body of the fourth example;

FIG. 7A is an illustrative top view showing a butt welding process in a sealed battery in accordance with a related art, and showing a welding site (site to be welded) between a lid body (pour hole) and a seal lid;

FIG. 7B is a sectional view taken along line A-A of FIG. 7A;

FIG. 8 is a top view showing a site of occurrence of welding failure in the sealed battery in accordance with the related art; and

FIG. 9 is a side sectional view showing a space formed between the lid body (pour hole) and the seal lid at the time of butt welding in the sealed battery in accordance with the related art;

FIG. 10A is a bottom view showing the configuration of a seal lid of another example of the foregoing embodiment of the invention;

FIG. 10B is a side view of the seal lid of the example;

FIG. 10C is a side sectional view showing the seal lid and a lid body in the example when the seal lid is to be welded to the lid body;

FIG. 10D is a side sectional view showing a vicinity of the pour hole of the lid body (without a seal lid) of the example;

FIG. 10E is a top view showing a vicinity of the pour hole of the lid body of the example.

### DETAILED DESCRIPTION OF EMBODIMENTS

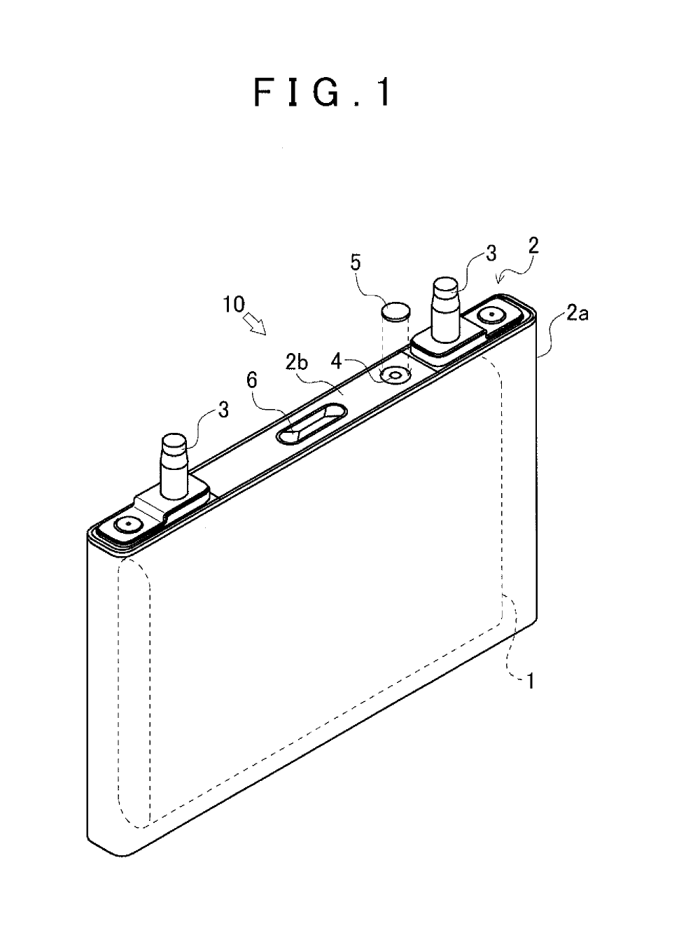

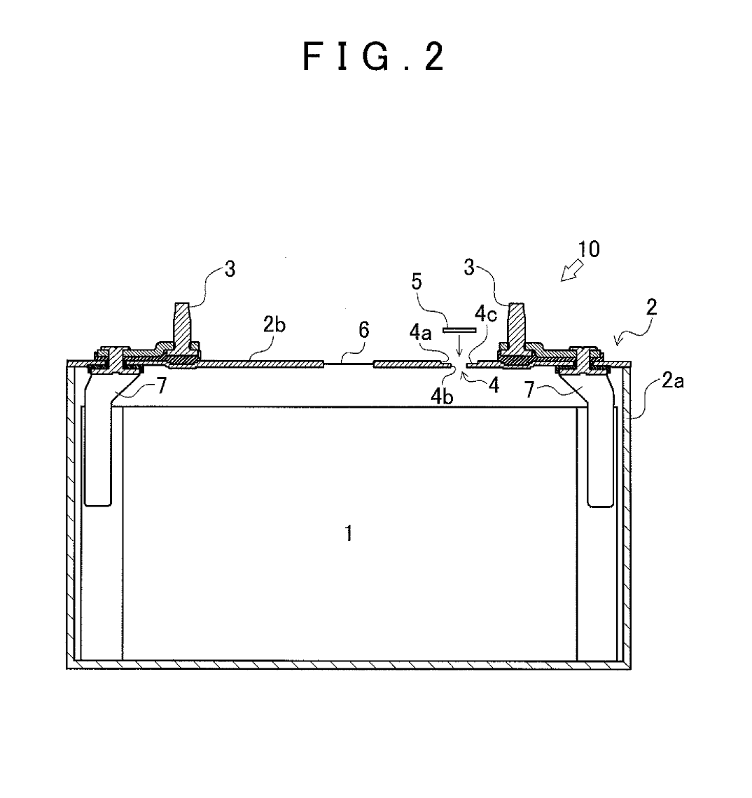

Embodiments of the invention will be described. Firstly, a construction of a battery 10 in accordance with an embodiment of the sealed battery of the invention will be described with reference to FIGS. 1 and 2. The battery 10 is a sealed battery (e.g., a lithium-ion secondary battery) configured to be capable of being charged and discharged in which a pour hole 4 and a seal lid 5 that is a seal member that seals the pour hole 4 are welded together by butt welding. The battery 10 will be concretely described below.

The battery 10 includes: a charge-discharge element 1; a battery case 2 in which the charge-discharge element 1 is housed; a pair of external terminals 3 and 3 protruded from an upper surface of the battery case 2; the pour hole 4 formed as an opening in the battery case 2 for use for pouring an electrolytic solution into the battery case 2; and the seal lid 5 provided as a seal member for sealing the pour hole 4.

The charge-discharge element 1 is an electrode body formed by rolling a plurality of times a laminate made up of a positive electrode and a negative electrode with a separator interposed therebetween. A laminate portion of the positive electrode and a laminate portion of the negative electrode are loaded with a mixture containing a positive electrode active material and a mixture containing a negative electrode active material, respectively. The charge-discharge element 1 is charged and discharged by chemical reactions between the positive electrode and the negative electrode in the laminate portions.

The battery case 2 is a metal member having a generally rectangular parallelepiped shape in which the charge-discharge element 1 is housed. The battery case 2 is formed as a generally rectangular battery container made up of a case body 2a, a lid body 2b, etc.

The case body 2a is a bottomed rectangular prismatic member one of whose surfaces (an upper surface in FIG. 1) is open and in which the charge-discharge element 1 is housed.

The lid body 2b is a flat planar member that has a shape (a generally rectangular shape in a plan view in the embodiment) commensurate with the open surface of the case body 2a and that closes the open surface of the case body 2a. The lid body 2b has in its substantially center portion a safety valve 6. The lid body 2b is a pour hole-formed member (hereinafter called as a pour hole member) in which the pour hole 4 is formed between the safety valve 6 and one of the external terminals 3 and 3. The lid body 2b is joined to the case body 2a by laser welding or the like after the opening surface of the case body 2a is closed with the lid body 2b. Examples of materials of the case body 2a and the lid body 2b include aluminum, aluminum alloys, etc. Incidentally, although the battery 10 of this embodiment is configured as a generally rectangular battery whose case body 2a has a bottomed prismatic shape, this configuration is not restrictive; for example, the embodiment is also applicable to a cylindrical battery whose case body has a bottomed cylindrical shape.

Of the external terminals 3 and 3, one is a positive terminal and the other is a negative terminal. The external terminals 3 and 3 are electrode terminals that serve as connecting paths to an external device outside the battery 10 for the purpose of charging and discharging. Portions of the external terminals 3 and 3 are protruded outward from the battery case 2. The external terminals 3 and 3, as shown in FIG. 2, are electrically connected to the positive electrode or the negative electrode of the charge-discharge element 1 via current-collecting terminals 7 and 7. The external terminals 3 and 3 are fixed to the lid body 2b via an insulating member.

The pour hole 4 is a through hole that extends through the lid body 2b in the thickness direction of the lid body 2b, and includes a large-diameter portion 4a that has a predetermined inside diameter, a small-diameter portion 4b that is smaller in diameter than the large-diameter portion 4a, and a circular annular portion (step surface) 4c formed between the large-diameter portion 4a and the small-diameter portion 4b. The pour hole 4 is used to pour an electrolytic solution into the battery case 2 in which the charge-discharge element 1 has been housed. The step portion 4c of the pour hole 4 serves as a facing portion to a reverse surface (inside surface) of the seal lid 5. The pour hole 4 is covered with the seal lid 5, and is sealed therewith by laser welding. Incidentally, although in the embodiment, the lid body 2b is used as a pour hole member that is provided with the pour hole 4, this is not particularly restrictive. It suffices that the pour hole is provided at such a position that the electrolytic solution can be poured into the battery case 2. Therefore, for example, it is possible to adopt a construction in which the case body 2a is used as a pour hole member and an upper portion of the case body 2a has a pour hole.

The seal lid 5 is a circular disc-shaped metal member that is smaller in diameter than the large-diameter portion 4a of the pour hole 4. The seal lid 5 is a seal member for sealing the pour hole 4. The seal lid 5 can be inserted into the large-diameter portion 4a of the pour hole 4 and can be placed on the step portion 4c of the pour hole 4. When the seal lid 5 is placed on the step portion 4c, an outside surface of the seal lid 5 (which refers to the upper surface thereof in FIG. 2) and an outside surface of the lid body 2b (which refers to the upper surface thereof in FIG. 2) substantially coincide with each other in the position in the thickness direction of the lid body 2b, that is, are flush with each other. Furthermore, the reverse surface of the seal lid 5 (the inside surface, which refers to the lower surface thereof in FIG. 2) serves as a facing portion to the step portion 4c of the pour hole 4. Examples of a material of the seal lid 5 include aluminum, aluminum alloys, etc. The seal lid 5 is inserted into the large-diameter portion 4a, and is placed on the step portion 4c of the pour hole 4, and then is joined to the lid body 2b by performing laser butt welding in a placement where the side wall surface of the large-diameter portion 4a and the outer peripheral surface of the seal lid 5 adjoin to each other (the “outer peripheral surface” refers to the outer peripheral surface of the cylindrical seal lid 5 that is a surface right-angled to the aforementioned outside surface of the seal lid 5, and that is shown in FIG. 2 as a vertical surface of the seal lid 5).

In the battery 10 of this embodiment, a flow channel that extends from a welding site (portion to be welded) to the opening portion of the pour hole 4 is formed by at least a portion of mutually facing portions of the reverse surface of the seal lid 5, which is a seal member, and of the lid body 2b (the pour hole 4), which is a pour hole member. Concrete examples of the flow channel will be presented below to further illustrate examples of the invention.

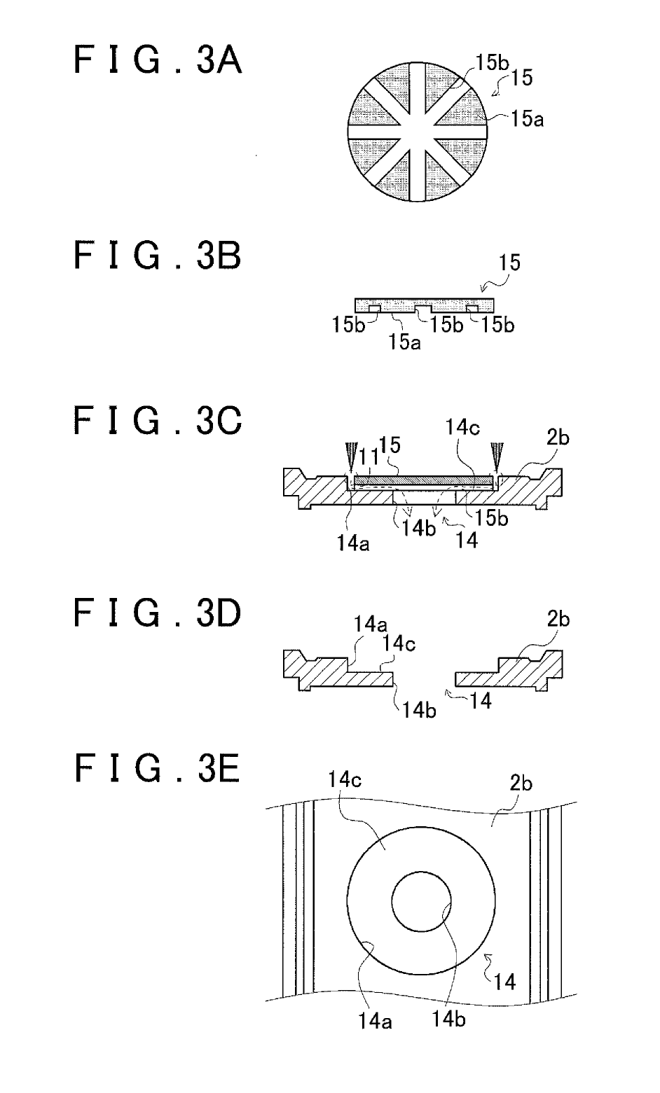

Firstly, a first example will be described with reference to FIGS. 3A to 3E. As shown in FIG. 3A, on the reverse surface (inside surface) 15a of the seal lid 15, grooves 15b extend radially from a center portion of the seal lid 15 to the outer peripheral edge. A sectional shape of the grooves 15b is rectangular (see FIG. 3B). On the other hand, the facing portion to the reverse surface 15a of the seal lie 15, that is, the step portion 14c of the pour hole 14, is formed as a flat surface having a circular annular shape. As shown in FIG. 3C, when the seal lid 15 is inserted into the large-diameter portion 14a, and is placed on the step portion 14c of the pour hole 14, the grooves 15b of the seal lid 15 form (or partially define) flow channels 11 that extend from the welded site at an outside portion (portion indicated by dotted-line circles in FIG. 3C) of the seal lid 15 in a placement where the outer peripheral surface of the seal lid 15 and the side wall surface of the large-diameter portion 14a adjoin to each other, to the opening portion (small-diameter portion 14b) of the pour hole 14. To seal the pour hole 14 with the seal lid 15 by welding, the seal lid 15 is inserted into the large-diameter portion 14a, and is placed on the step portion 14c of the pour hole 14, and the welding site is irradiated with laser to carry out butt welding. If gas (e.g., vapor of an extraneous substance, such as an electrolytic solution residue, etc.) is produced by the effect of heat at the time of welding, the gas passes through the flow channels 11 in the directions of dotted-line arrows shown in FIG. 3C, and then flows into the battery case 2. Furthermore, since the flow channels 11 that extend from the welding site to the opening portion of the pour hole 14 are formed, air will not be confined within a space between the lid body (pour hole wall surface) and the seal lid, unlike the related art. Thus, continuous welding of the welding site becomes possible, and it is no longer necessary to perform welding a plurality of times as required in the related art. By adopting such a construction that the gas produced by the effect of heat at the time of welding escapes toward the large space within the battery case 2, it is possible to prevent welding failure. Incidentally, the number of grooves 15b, the sectional shape thereof, etc. are not particularly limited.

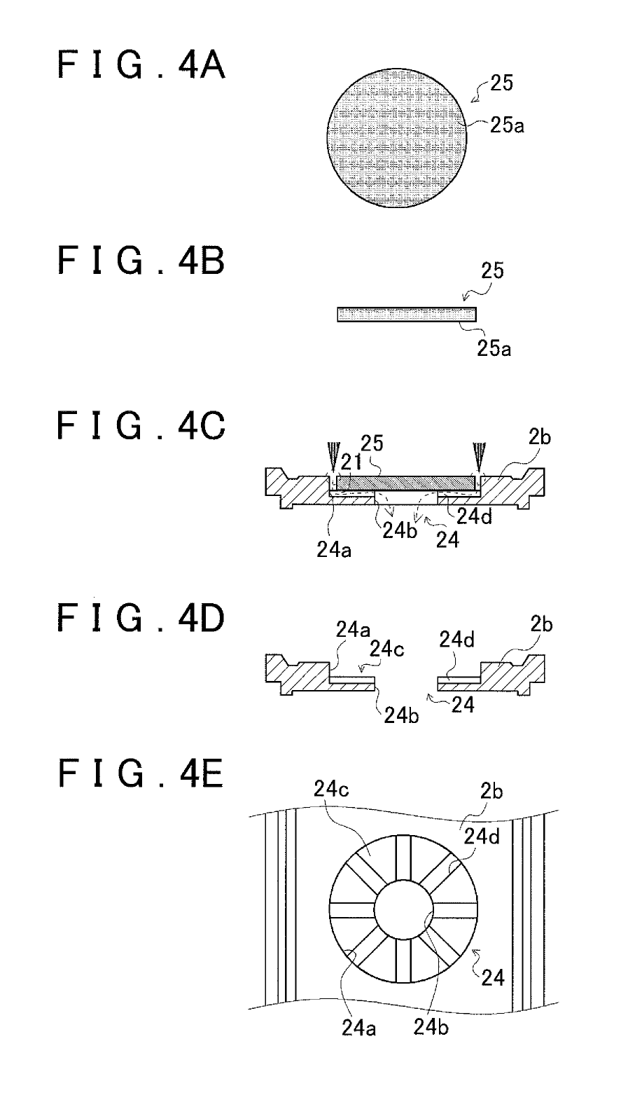

Next, a second example will be described with reference to FIGS. 4A to 4E. As shown in FIG. 4E, a step portion 24c of a pour hole 24 is provided with grooves 24d that extend radially from a small-diameter portion 24b of the pour hole 24 to a large-diameter portion 24a of the pour hole 24. The grooves 24d have a rectangular sectional shape. On the other hand, a reverse surface (inside surface) 25a of a seal lid 25 which is a facing portion to the step portion 24c of the pour hole 24 is formed as a flat surface. As shown in FIG. 4C, when the seal lid 25 is inserted into the large-diameter portion 24a, and is placed on the step portion 24c of the pour hole 24, the grooves 24d of the pour hole 24 form (or partially define) flow channels 21 that extend from the welded site at an outside portion (portion indicated by dotted-line circles in FIG. 4C) of the seal lid 25 in a placement where the outer peripheral surface of the seal lid 25 and the side wall surface of the large-diameter portion 24a adjoin to each other, to the opening portion (small-diameter portion 24b) of the pour hole 24. To seal the pour hole 24 with the seal lid 25 by welding, the seal lid 25 is inserted into the large-diameter portion 24a, and is placed on the step portion 24c of the pour hole 24, and the welded site is irradiated with laser to carry out butt welding. If gas (e.g., vapor of an extraneous substance, such as an electrolytic solution residue, etc.) is produced by the effect of heat at the time of welding, the gas passes through the flow channels 21 in the directions of dotted-line arrows shown in FIG. 4C, and then flows into the battery case 2. Furthermore, since the flow channels 21 that extend from the welded site to the opening portion of the pour hole 24 are formed, air will not be confined within a space between the lid body (pour hole wall surface) and the seal lid, unlike the related art. Thus, continuous welding of the welding site becomes possible, and it is no longer necessary to perform welding a plurality of times as required in the related art. By adopting such a construction that the gas produced by the effect of heat at the time of welding escapes toward the large space within the battery case 2, it is possible to prevent welding failure. Incidentally, the number of grooves 24d, the sectional shape thereof, etc. are not particularly limited. Furthermore, although in this example, the step portion 24c of the pour hole 24 is provided with the grooves 24d, it is also possible to adopt a construction in which the seal lid 25 employed in this example is replaced by the seal lid 15 employed in the first example and, therefore, the step portion 24c of the pour hole 24 and the reverse surface 15a of the seal lid 15 have the grooves 24d and the grooves 15b, respectively. This construction further improves the gas conducting capacity of the flow channels formed.

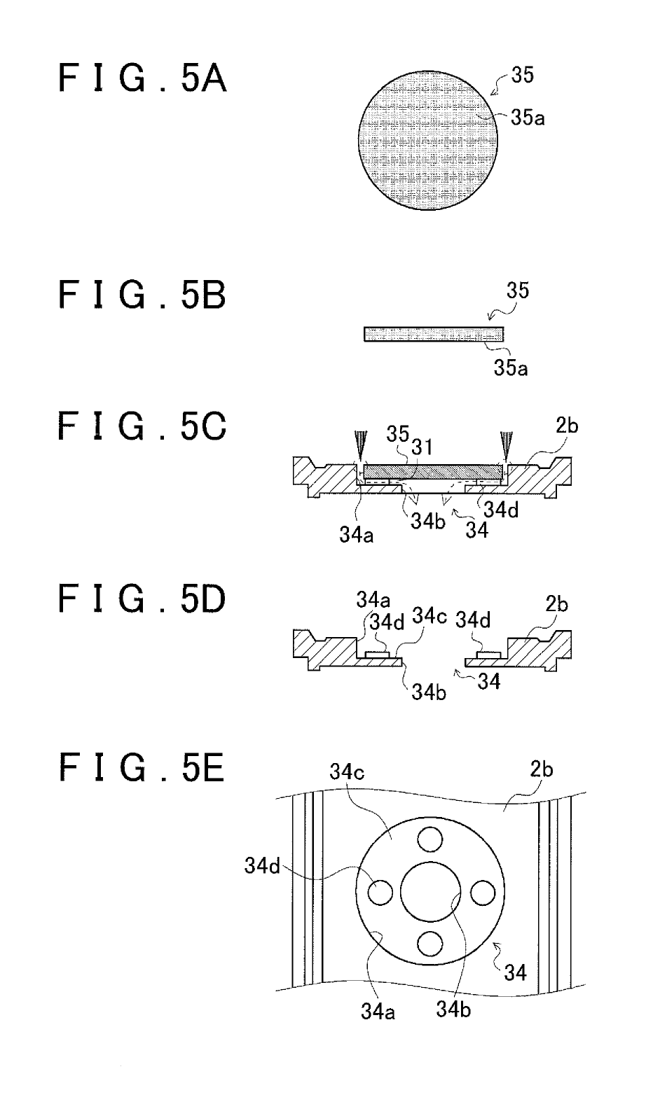

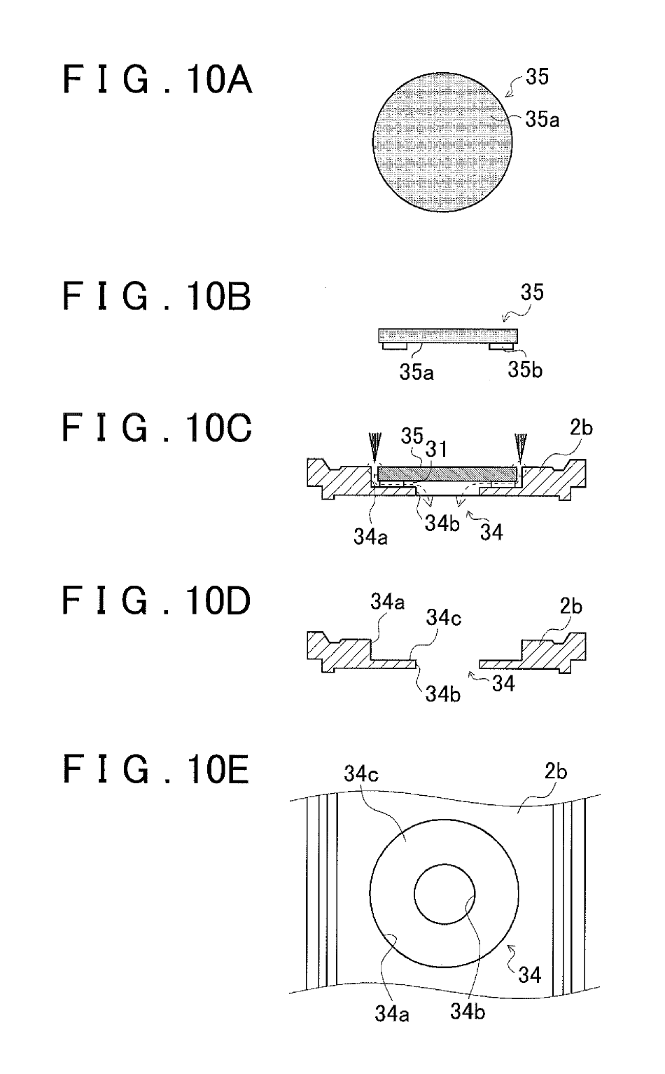

Next, a third example will be described with reference to FIGS. 5A to 5E As shown in FIG. 5E, a step portion 34c of a pour hole 34 is provided with protrusions 34d at four substantially equidistant locations around a small-diameter portion 34b of the pour hole 34. The protrusions 34d are cylindrical protrusions. On the other hand, a reverse surface (inside surface) 35a of a seal lid 35 which is a facing portion to the step portion 34c of the pour hole 34 is formed as a flat surface. As shown in FIG. 5C, when the seal lid 35 is inserted into a large-diameter portion 34a of the pour hole 34, and is placed on the step portion 34c of the pour hole 34, the protrusions 34d of the pour hole 34 form (or partially define) flow channels 31 that extend from the welded site at an outside portion (portion indicated by dotted-line circles in FIG. 5C) of the seal lid 35 in a placement where the outer peripheral surface of the seal lid 35 and the side wall surface of the large-diameter portion 34a adjoin to each other, to the opening portion (small-diameter portion 34h) of the pour hole 34. To seal the pour hole 34 with the seal lid 35 by welding, the seal lid 35 is inserted into the large-diameter portion 34a, and is placed on upper surfaces of the protrusions 34d provided on the step portion 34c of the pour hole 34, and the welding site is irradiated with laser to carry out butt welding. If gas (e.g., vapor of an extraneous substance, such as an electrolytic solution residue, etc.) is produced by the effect of heat at the time of welding, the gas passes through the flow channels 31 in the directions of dotted-line arrows shown in FIG. 5C, and then flows into the battery case 2. Furthermore, since the flow channels 31 that extend from the welded site to the opening portion of the pour hole 34 are formed, air will not be confined within a space between the lid body (pour hole wall surface) and the seal lid, unlike the related art. Thus, continuous welding of the welding site becomes possible, and it is no longer necessary to perform welding a plurality of times as required in the related art. By adopting such a construction that the gas produced by the effect of heat at the time of welding escapes toward the large space within the battery case 2, it is possible to prevent welding failure. Incidentally, although in this example, the step portion 34c of the pour hole 34 is provided with the protrusions 34d, this is not restrictive. For example, as shown in FIGS. 10A-10E as another example of the embodiment, it is also possible to adopt a construction in which protrusions 35b are provided not on the step portion 34c of the pour hole 34 but on the reverse surface of the seal lid 35, which will achieve substantially the same effects as the third example. Furthermore, the number of protrusions 34d, the shape thereof, etc. are not particularly limited.

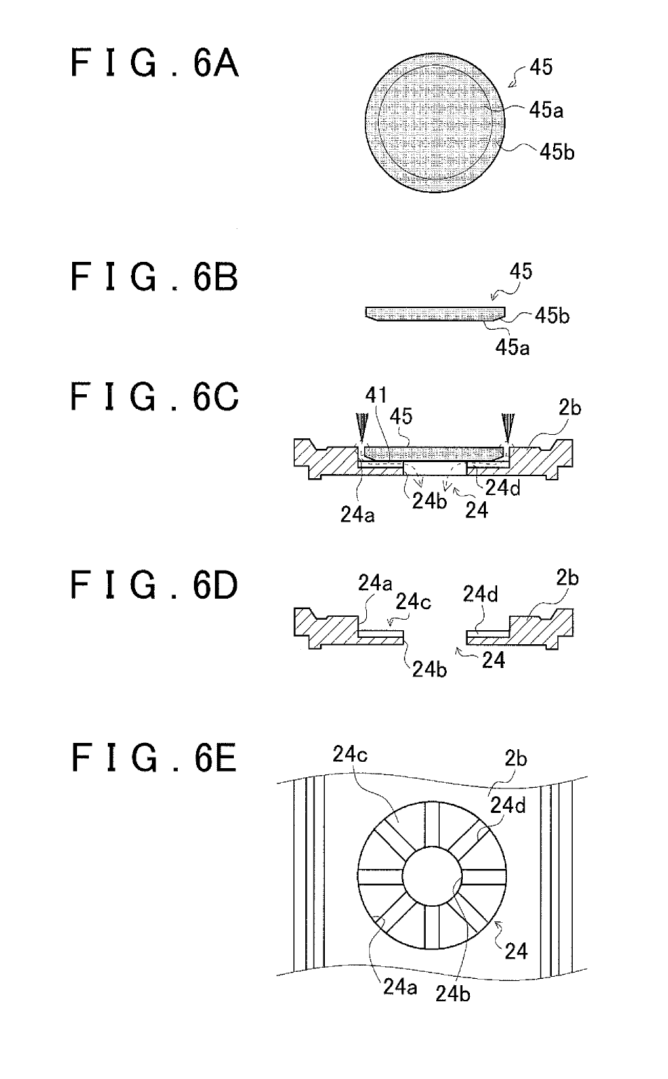

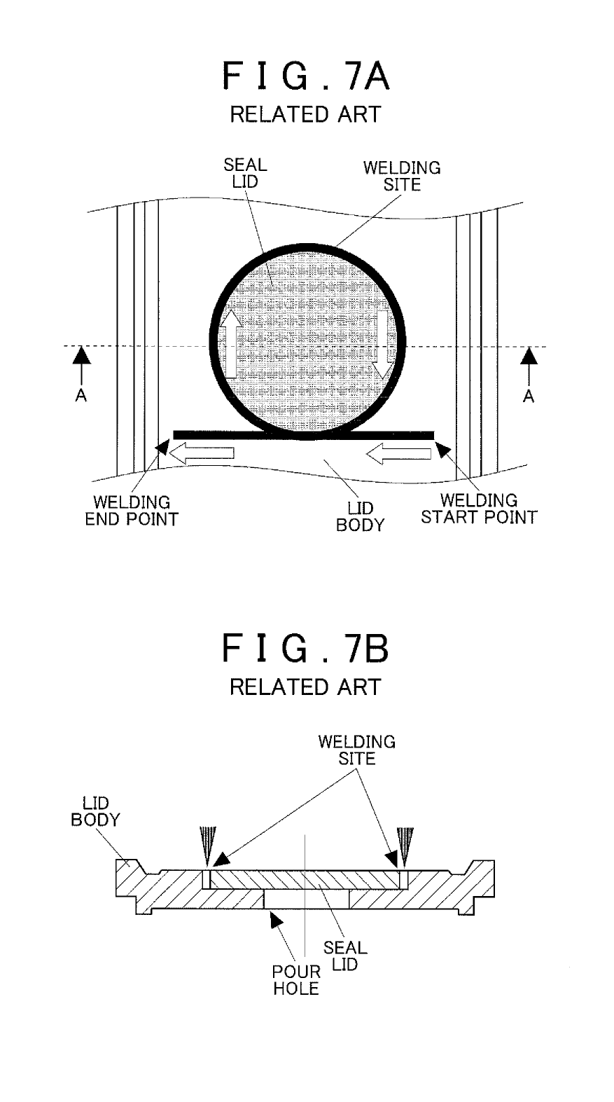

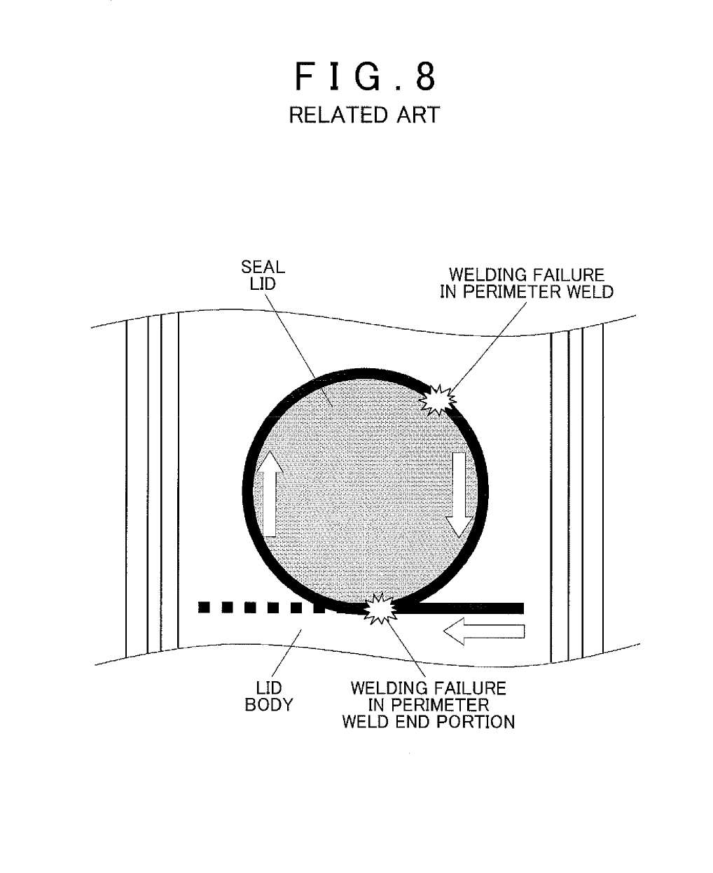

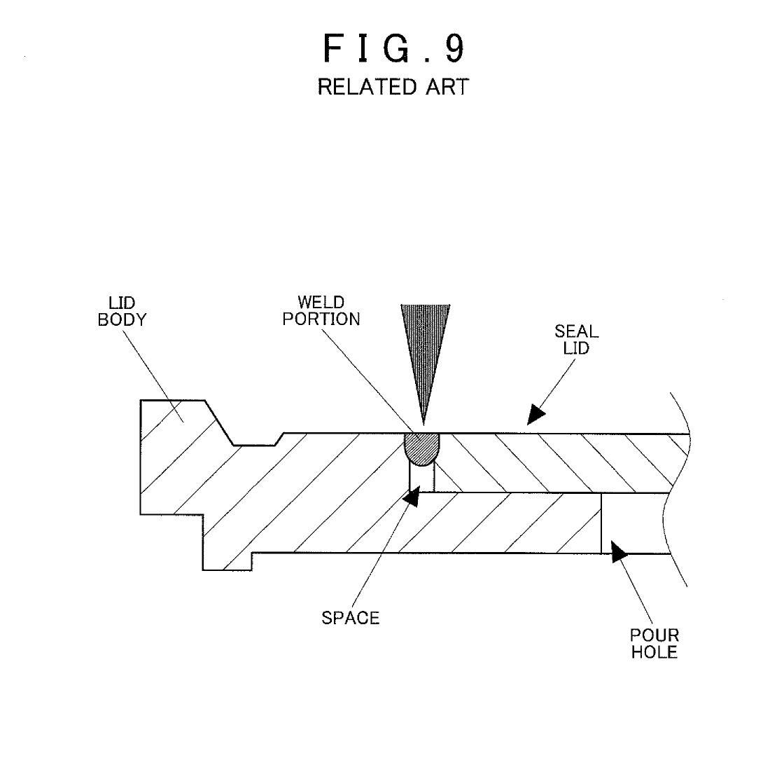

Next, a fourth example will be described with reference to FIGS. 6A to 6E. As for the configurations of the seal lid and the pour hole shown as the fourth example, the fourth example is different from the second example only in that the seal lid of the fourth example is different in configuration from the seal lid 25 of the second example. Therefore, the fourth example will be described only with respect to a seal lid 45 that replaces the seal lid 25 of the second example. As shown in FIGS. 6A and 6B, the seal lid 45 has a tapered portion 45b at a peripheral end portion of the reverse surface (inside surface) 45a (a portion of the reverse surface 45a which adjoins to the side wall surface of the pour hole 24). The tapered portion 45b is formed so that the thickness of the seal lid 45 becomes smaller toward the outer peripheral edge. As shown in FIG. 6C, when the seal lid 45 is inserted into a large-diameter portion 24a of the pour hole 24, and is placed on the step portion 24c of the pour hole 24, the grooves 24d of the pour hole 24 form (or partially define) flow channels 41 that extend from the welded site at an outside portion (portion indicated by dotted-line circles in FIG. 6C) of the seal lid 25 in a placement where the outer peripheral surface of the seal lid 25 and the side wall surface of the large-diameter portion 24a adjoin to each other, to the opening portion (small-diameter portion 24b) of the pour hole 24. To seal the pour hole 24 with the seal lid 45 by welding, the seal lid 25 is inserted into the large-diameter portion 24a, and is placed on the step portion 24c of the pour hole 24, and the welding site is irradiated with laser to carry out butt welding. If gas (e.g., vapor of an extraneous substance, such as an electrolytic solution residue, etc.) is produced by the effect of heat at the time of welding, the gas passes through the flow channels 41 in the directions of dotted-line arrows shown in FIG. 6C, and then flows into the battery case 2. Furthermore, in this example, since the tapered portion 45b is provided in the vicinity of the welded site, the flow channels 41 can more smoothly relieve the gas produced by the effect of heat at the time of welding to the opening portion of the pour hole 24 than the flow channels 21 shown above in the second example. Furthermore, since the flow channels 41 that extend from the welded site to the opening portion of the pour hole 24 are formed, air will not be confined within a space between the lid body (pour hole wall surface) and the seal lid, unlike the related art. Thus, continuous welding of the welding site becomes possible, and it is no longer necessary to perform welding a plurality of times as required in the related art. By adopting such a construction that the gas produced by the effect of heat at the time of welding escapes toward the large space within the battery case 2, it is possible to prevent welding failure.

As described above, in the invention, at least a portion of the mutual facing portions (adjoining portions) of the reverse surface of the seal lid, which is a seal member, and the lid body (pour hole), which is a pour hole member, is provided with a flow channel that extends from the welded site to the pour hole opening portion. Furthermore, the flow channel is formed or partially defined by a groove or a protrusion that is provided on the reverse surface of the seal lid. Further, the flow channel is partially defined by a groove or a protrusion that is provided on the lid body (pour hole). This arrangement provides a construction such that it is not necessary to perform welding a plurality of times as required in the related art, and such that the gas produced by heat at the time of welding escapes through the gas relief flow channel toward the large space within the battery case. Therefore, welding failure can be prevented. That is, in the invention, in order to prevent welding failure at the welded site, the configurations of the pour hole and the seal lid are designed so as to provide such a structure that gas pressure escapes into the battery case.

While the invention has been described with reference to example embodiments thereof, it is to be understood that the invention is not limited to the described example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A sealed battery comprising:
a battery case including a pour hole member provided with a pour hole, the battery case housing a charge-discharge element; and
a seal member sealing the pour hole, the seal member being butt-welded with the pour hole member, at least a portion at which a reverse surface of the seal member faces the pour hole member each other having a flow channel, and the flow channel extending from a welded site to an opening portion of the pour hole.

2. The sealed battery according to claim 1, wherein
the seal member includes a groove on the reverse surface of the seal member and the flow channel includes the groove.

3. The sealed battery according to claim 2, wherein
the seal member includes a plurality of the grooves on the reverse surface of the seal member, the plurality of the grooves extending radially.

4. The sealed battery according to claim 1, wherein
the pour hole member includes a groove on the pour hole member and the flow channel includes the groove.

5. The sealed battery according to claim 4, wherein
the pour hole member includes a plurality of the grooves, the plurality of the grooves extending radially.

6. The sealed battery according to claim 4, wherein
the seal member has a tapered portion on a peripheral end portion of the reverse surface of the seal member.

7. The sealed battery according to claim 1, wherein
the seal member includes a protrusion on the reverse surface of the seal member and the flow channel is provided using the protrusion.

8. The sealed battery according to claim 7, wherein
the reverse surface of the seal member includes a plurality of the protrusions on the reverse surface of the seal member.

9. The sealed battery according to claim 1, wherein
the pour hole member includes a protrusion on the pour hole member and the flow channel is provided using the protrusion.

10. The sealed battery according to claim 9, wherein
the pour hole member includes a plurality of the protrusions.
